(19) United States
(12) Patent Application Publication
(10) Pub. No.: US 2006/0143628 A1
(43) Pub. Date: Jun. 29, 2006

(54) Slot-in optical disk drive with transmission belt

(76) Inventor: Min-Cheng Yang, Longjing Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/048,943

(22) Filed: Feb. 3, 2005

(30) Foreign Application Priority Data
Dec. 28, 2004 (TW) 093221051

(51) Int. Cl. G11B 17/04

(52) U.S. Cl. 720/619

(57) ABSTRACT

A slot-in optical disk drive with a transmission belt includes a base chassis with sliding slots on two sides for accommodating sliding boards. Each of the sliding boards on two sides of the base chassis having a rail member with a guide slot. A driving pulley is disposed on one end of the rail member of the sliding board on one side of the base chassis. A transmission belt is put on the driving pulley and the guide slot. By the matching of the driving mechanism and the driving pulley, the driving pulley is rotated to drive the transmission belt. One end of a synchronous link is disposed on each of the sliding boards while the other end thereof is connected with a synchronously gear. The two synchronously gears engage with each other. When the optical disk is loaded into the disk drive, the optical disk enters the guide slots on two sides and pushes the sliding boards to move toward the two sides of the base chassis. The driving mechanism drives the transmission belt to move the optical disk into the disk drive for retrieving data.

### BACKGROUND OF THE INVENTION

The present invention relates to a slot-in optical disk drive, especially to a slot-in optical disk drive that drives optical disks into the disk drive by a transmission belt for retrieving data of the disks.

By the development of the internet technology, a lot of multimedia information is transmitted through internet. A plurality of websites provides the free download service of software and multimedia data such as movies or music. Thus the need for copy and storage of data is increasing dramatically. Therefore, a media with large storage capacity such as hard disc drive, memory sticks and optical disks for recording large capacity multimedia data is getting more popular. The portable storage device should be compact, light and easy to use. Therefore, optical disks has become the most popular storage media now and thus optical disk drives has become one of the essential equipments on computer systems for retrieving data from optical disks.

People care about product weight and efficiency while buying electronics products. In earlier days, the optical disk drives are tray-loading type. Users need to control the loading process of optical disks and wait for a period of time of movement of the tray. It's a cumbersome and time-consuming process. Thus a slot-in disk drive that pushes disks in automatically is developed for convenience and efficiency of users. However, most of the slot-in disk drive available now uses pulleys to drive the optical disk into the disk drive, such as an embodiment disclosed in Taiwanese utility model publication No. 555131. The slot-in optical disk drives an optical disk into the disk drive by pulleys that contact the data area of the optical disk and may cause damage.

Moreover, some kind of slot-in disk drives drive an optical disk into the disk drive by a link thereof, such as an embodiment disclosed in U.S. Pat. No. 6,577,579. Such kind of optical disk drive has a lot of mechanisms therein and complicated structure. Thus the high mechanical tolerance reduces the accuracy for retrieving data from an optical disk and the production cost is high.

Therefore, a slot-in disk drive with a transmission belt that drives optical disk inside the disk drive without contacting the data area of the optical disk, simplifies the loading process, reduces the mechanical tolerance, enhances the disk data retrieving efficiency and decreases the manufacturing cost is provided.

### SUMMARY OF THE INVENTION

Therefore, it is a primary object of the present invention to provide a slot-in optical disk drive that drives optical disks into the disk drive through a transmission belt so as to avoid the contact of data area of the optical disks and increase the lifetime of data inside the optical disks.

It is another object of the present invention to provide a slot-in optical disk drive with a transmission belt that has simple structure, reduced mechanical tolerance, and lower manufacturing cost.

A slot-in optical disk drive with a transmission belt in accordance with the present invention includes a base chassis and a first sliding slot as well as a second sliding slot on right and left sides of the base chassis for being inserted by a first sliding board and a second sliding board respectively. A first rail member with a driving pulley on one end thereof is arranged on the first sliding board while a second rail member is disposed on the second sliding board. A first guide slot is set on the first rail member and a second guide slot is disposed on the second rail member. A transmission belt is put on the first guide slot as well as the driving pulley. One end of a first synchronous link is arranged on top of the first sliding board while the other end thereof is connected with a first synchronous gear on the base chassis. The first synchronous gear engages with a second synchronous gear that is connected with a second synchronous link. The other end of the second synchronous link is inserted on the second sliding board.

When an optical disk is driven into a disk drive, two sides of the optical disk slides inside the first guide slot and the second guide slot and then further pushes the first sliding board and the second sliding board synchronously moving toward two sides of the base chassis respectively. A driving mechanism rotates the driving pulley to drive the transmission belt. Thus the optical disk is driven into the disk drive and is positioned. Then a turn table of a traverse inserts a central hole of the optical disk for rotating and retrieving data from the optical disk.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a schematic drawing of an assembling view of an embodiment in accordance with the present invention;

FIG. 2 is an explosive view of an embodiment in accordance with the present invention;

FIG. 3 is a schematic drawing showing initial position of an optical disk while entering a disk drive in accordance with the present invention;

FIG. 4 is a schematic drawing showing the position of the optical disk while inside the disk drive in accordance with the present invention;

FIG. 5 is a schematic drawing showing the position of the optical disk while being retrieved data by the disk drive in accordance with the present invention.

### DETAILED DESCRIPTION OF THE PREFFERED EMBODIMENT

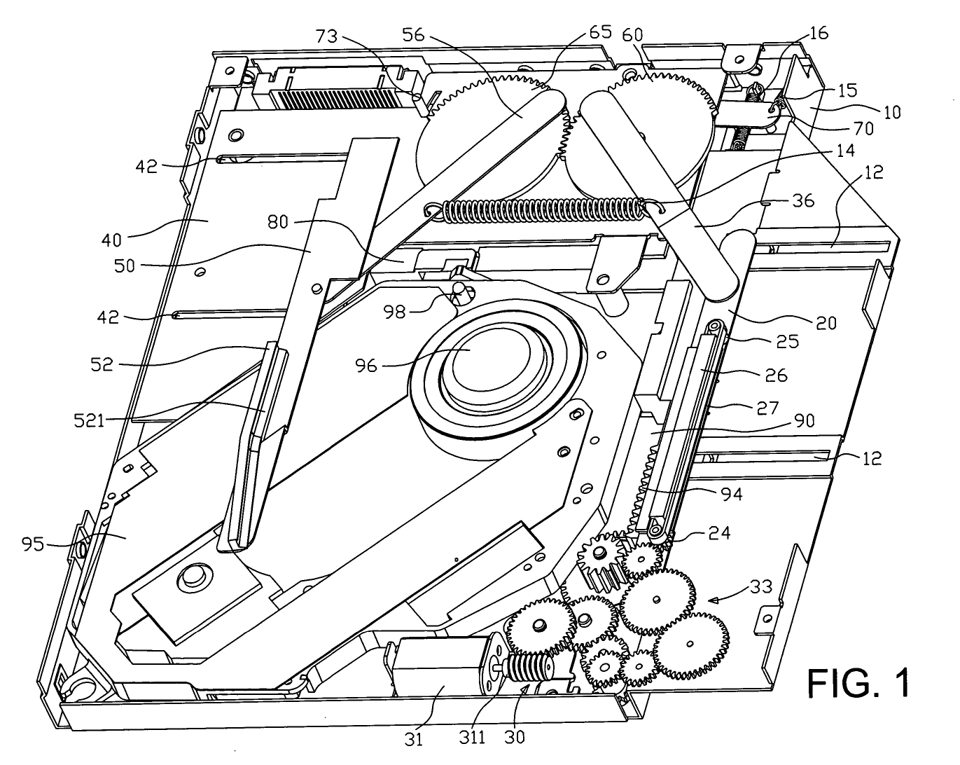

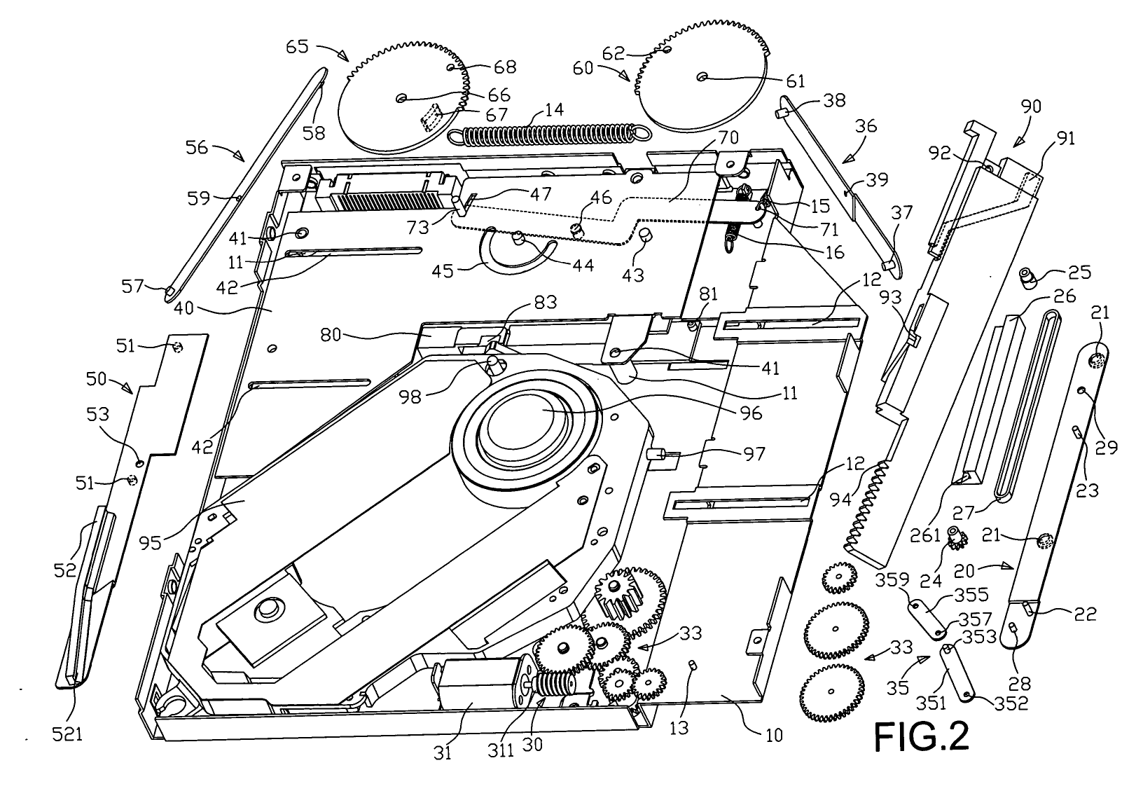

Refer to FIG. 1 & FIG. 2, the present invention includes a base chassis 10 with a plurality of first sliding slot 12 on one lateral side thereof. A first sliding post 21 is disposed on the bottom of a first sliding board 20, corresponding to the first sliding slot 12, for inserting the first sliding slot 12 so that the first sliding board 20 slides on the base chassis 10. Two locating posts 22, 23 are arranged on the first sliding board 20 for inserting a driving pulley 24 and a following pulley 25 respectively. The driving pulley 24 is a toothed pulley. Moreover, a first rail member 26 with a first guide slot 261 is disposed between the driving pulley 24 and the following pulley 25 while a transmission belt 27 is assembled with the driving pulley 24, the following pulley 25 and the first guide slot 261. The transmission belt 27 can be a belt.

By the driving pulley 24 and a driving mechanism 30 on the base chassis 10, the transmission belt 27 works. The driving mechanism 30 consists of a motor 31, a driving gear set 33, and a driving linkage mechanism 35 having a first driving link 351 as well as a second driving link 355. By an insertion hole 352 disposed on one end of the first driving link 351 being inserted with a projective post 13 on the base chassis 10, the first driving link 351 is arranged on the base chassis 10. A positioning post 353 set on the other end of the first driving link 351 inserts through an insertion hole 357 on one end of the second driving link 355 while an insertion hole 359 on the other end of the second driving link 355 is inserted by a positioning post 28 installed on one end of the first sliding board 20. The driving gear set 33 is disposed on the base chassis 10 and the driving linkage mechanism 35, engaging with the driving pulley 24 as well as a worm 311 of the motor 31 so as to drive the driving pulley 24 and further drive the transmission belt 27.

Corresponding to the first sliding board 20, a base board 40 is disposed on the base chassis 10 by a plurality of fixing post 11 on the base chassis 10 inserting through a plurality of fixing hole 41 on the base board 40 respectively. A plurality of second sliding slot 42 is arranged on the base board 40 on the side corresponding to the first sliding board 20. Moreover, a second sliding post 51 is disposed on the bottom of a second sliding board 50, located on the position corresponding to the second sliding slot 42 for inserting into the second sliding slot 42 so that the second sliding board 50 slides on the base board 40. A second rail member 52 with a second guide slot 521 is installed on the second sliding board 50.

Furthermore, a first synchronous gear 60 and a second synchronous gear 65 engage with each other are disposed on top of the base board by projective posts 43, 44 on the base board 40 inserting through central holes 61, 66 on the first synchronous gear 60 and the second synchronous gear 65 respectively. An arched slot 45 is disposed on the base board 40, corresponding to the second synchronous gear 65 while a starting block 67 is set on the bottom of the second synchronous gear 65 for inserting into the arched slot 45. Thus when the second synchronous gear 65 rotates, the starting block 67 contacts a starting switch on the base chassis 10 so as to activate the motor 31 of the driving mechanism 30.

Assembling posts 37, 38 disposed on two ends of a first synchronous link 36 are matched with an assembling (pilot) hole 29 on one end of the first sliding board 20 and an assembling (pilot) hole 62 of the first synchronous gear 60 respectively. A second synchronous link 56 is disposed between the second sliding board 50 and the second synchronous gear 65. Assembling posts 57, 58 disposed on two ends of the second synchronous link 56 are assembled with an assembling (pilot) hole 53 of the second sliding board 50 and an assembling (pilot) hole 68 of the second synchronous gear 65 respectively. The first synchronous link 36 as well as the second synchronous link 56 has a hook hole 39, 59 respectively for hooking with an elastic component 14.

A positioning bar 70 is disposed on the bottom of the base board 40 by an insertion hole on the positioning bar 70 hooked with a projective post 46 of the base board 40. A hook hole 71 and a positioning post 73 are arranged on two ends of the positioning bar 70 respectively. The hook hole 71 is hooked with an elastic component 15 that has one end hooked on the base chassis 10 while the positioning post 73 inserts through an insertion slot 47 on the base board 40 for positioning the optical disks while entering the disk drive.

A transverse-moving member 80 is disposed on the base chassis 10. A transverse-moving post 81 is arranged on one end of the transverse-moving member 80 while a first lift slot 83 with slope is disposed on lateral side of the transverse-moving member 80. A sliding member 90 with a transverse-moving slot 91 on the bottom thereof is disposed on the base chassis 10, beside the first sliding board 20. The transverse-moving slot 91 matches with the transverse-moving post 81 of the transverse-moving member 80. The sliding member 90 further having a hook hole 92 on one end thereof for hooking with an elastic component 16 and a second lift slot 93 on lateral side thereof. By a projective panel on the first sliding slot 12, the upward and downward movement of the sliding member 90 is limited. By the transverse-moving post 81 assembling with the transverse-moving slot 91, the direction of movement of the sliding member 90 is limited. A gear rack 94 is arranged on the lateral side of the lower part of the sliding member 90 for engaging with the driving gear set 33 so that the gear rack 94 is driven to move the sliding member 90.

A traverse 95 is installed on the lower part of the base chassis 10. A turn table 96 for inserting a central hole of optical disks and retrieving data is disposed on the traverse 95 while a lift arm 97 disposed on each lateral side of the front end of the traverse 95 is mounted on the first lift slot 83 and the second lift slot 93 respectively. When the transmission belt 27 drives the optical disk into the disk drive, the driving mechanism 30 makes the sliding member 90 to move thus the sliding member 90 drives the transverse-moving member 80 and the first lift slot 83 as well as the second lift slot 93 guides the lift arms 97 to move upwards so that the traverse 95 moves upwards for loading the positioned optical disk on the turn table 96.

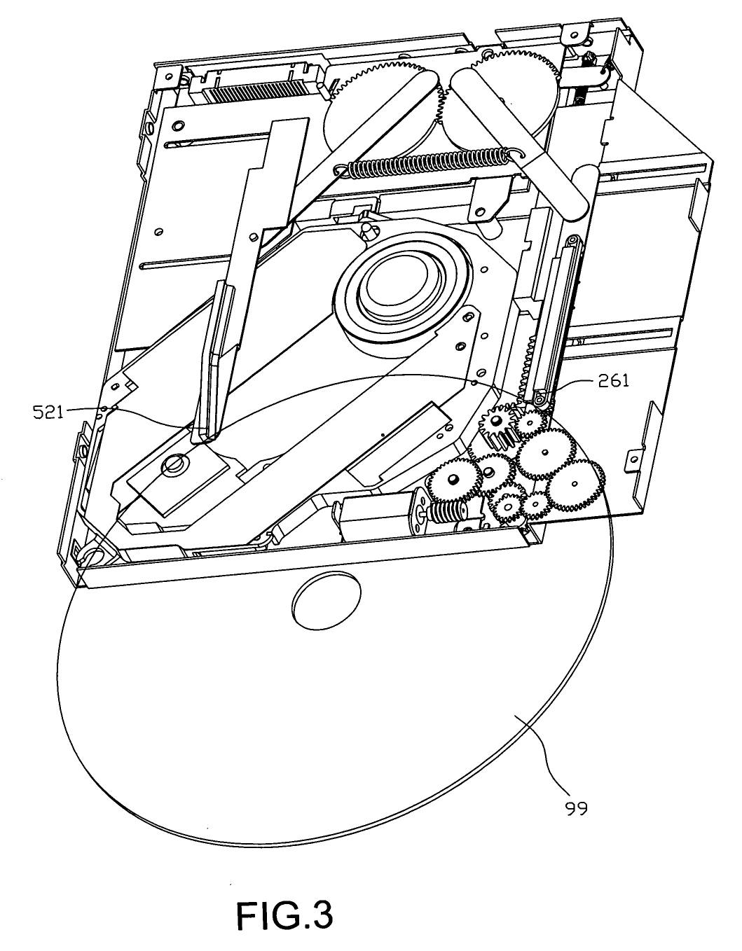

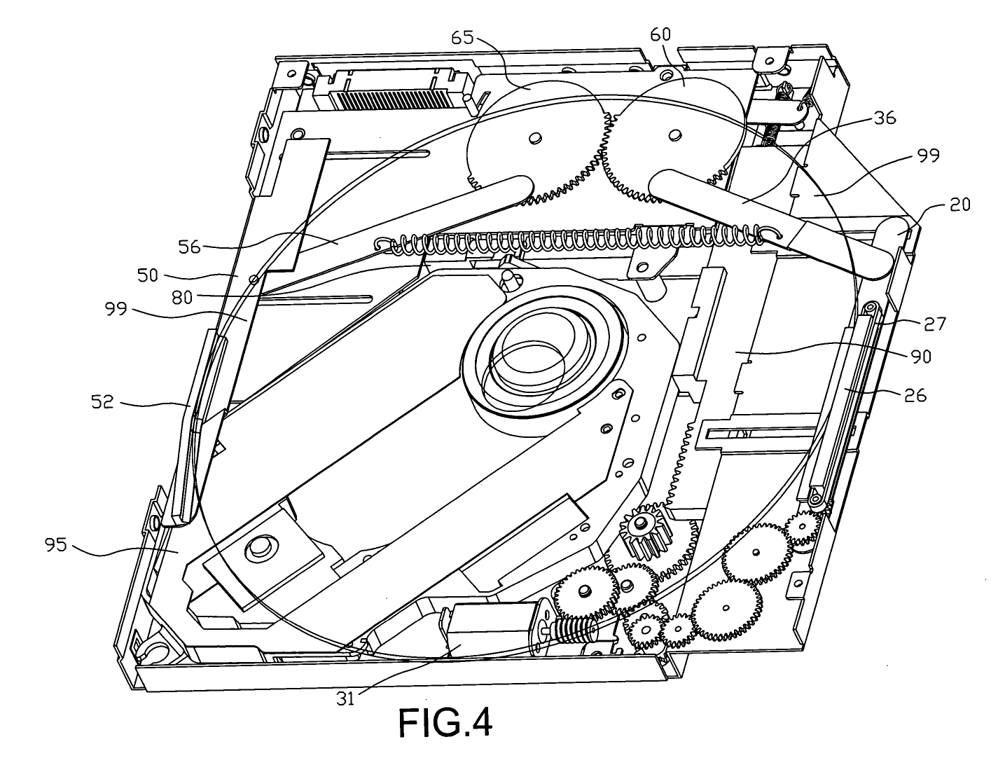

When users want to read data from an optical disk 99, refer to FIG. 3, the optical disk 99 is pushed to enter the disk drive, left and right sides of the optical disk 99 are sliding inside the first guide slot 261 and the second guide slot 521. Then the optical disk 99 keeps moving inside the disk drive, as shown in FIG. 4, the optical disk 99 pushes the first rail member 26 and the second rail member 52 so that the first sliding board 20 and the second sliding board 50 moves toward the right and left sides of the base chassis 10. The first sliding board 20 and the second sliding board 50 are connected with the first synchronous link 36 and the second synchronous link 56 respectively while the first synchronous link 36 and the second synchronous link 56 are engaged with the first synchronous gear 60 and a second synchronous gear 65. Thus the first sliding board 20 and the second sliding board 50 are moving synchronously. When the second synchronous gear 65 rotates, the starting block 67 thereof contacts the starting switch and activates the motor 31 to drive the transmission belt 27 for moving the optical disk 99 into the disk drive. The transmission belt 27 only contacts the edge of the optical disk 99, without touching the data area of the optical disk 99. Thus the data stored therein won't get damage.

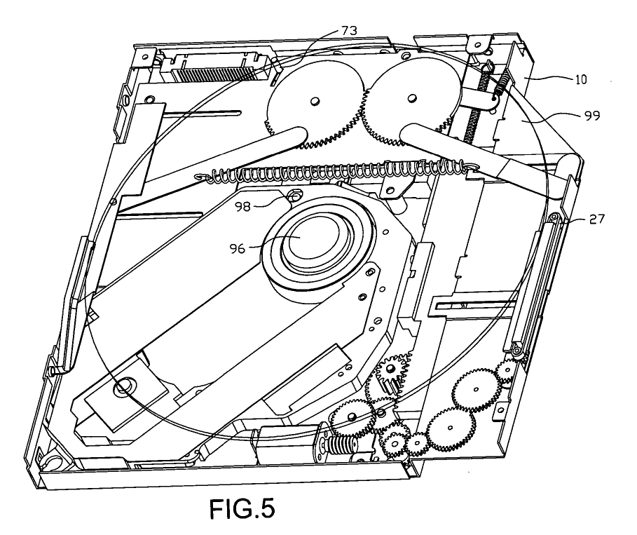

When the driving mechanism 30 drives the transmission belt 27, it also makes the sliding member 90 to move. At the same time, the transverse-moving post 81 of the transverse-moving member 80 slides inside the transverse-moving slot 91 of the sliding member 90 so as to drive the transverse-moving member 80 moving toward the sliding member 90. Thus, the first lift slot 83 of the transverse-moving member 80 as well as the second lift slot 93 of the sliding member 90 drives the transverse 95 to move upwards for positioning the optical disk 99. Therefore, as shown in FIG. 5, the positioning post 73 on top of the base chassis 10 presses against the top of the optical disk 99 for positioning so that the central hole of the optical disk 99 turns to the turn table 96 and the turn table 96 moves upwards to load the optical disk 99. The optical disk 99 is rotated for retrieving data therein.

In addition, a press post 98 is disposed on the base chassis 10. When users want to unload the optical disk 99, by pressing the unload button of the disk drive, the motor 31 is activated and rotates reversely so as to drive the sliding member 90 moving downward. Then the first lift slot 83 and the second lift slot 93 guide the lift arm 97 to move downward while the press post 98 is used to unload the optical 99 out of the turn table 96. The transmission belt 27 acts in reverse direction to eject the optical disk 99 out of the disk drive.

In summary, a slot-in optical disk drive in accordance with the present invention drives the optical disk 99 in or ejects the optical disk 99 out of the disk drive by a transmission belt 27. Thus the structure of the slot-in optical disk drive is simplified and the manufacturing cost is reduced. And there is no contact of the data area of the optical disk 99 during the optical disk driving process so that the lifetime of data inside the optical disk 99 is increased.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A slot-in optical disk drive with a transmission belt comprising:
a base chassis with at least one first sliding slot and one second sliding slot on two sides thereof;
a first sliding board with a driving pulley on one end thereof mounted on the first sliding slot;
a first rail member with a first guide slot thereof disposed on the first sliding board;
a transmission belt put on the first guide slot and the driving pulley;
a second sliding board inserted in the second sliding slot;
a second rail member with a second guide slot thereof installed on the second sliding board;
a first synchronous gear disposed on top of the base chassis;
a second synchronous gear arranged on top of the base chassis and engaged with the first synchronous gear;
a first synchronous link with two ends thereof connected to the first sliding board and the first synchronous gear respectively;
a second synchronous link with two ends thereof connected to the second sliding board and the second synchronous gear respectively;
a driving mechanism disposed on the base chassis for rotating the driving pulley to drive the transmission belt;
wherein when an optical disk is loaded on the disk drive, the optical disk enters the first guide slot and the second guide slot and pushes the first sliding board and the second sliding board to move toward the two sides of the base chassis synchronously while the driving mechanism drives the transmission belt to move the optical disk into the disk drive for retrieving data.

2. The device according to claim 1, wherein at least one first sliding post is disposed on the first sliding board, corresponding to the first sliding slot, and is mounted inside the first sliding slot.

3. The device according to claim 1, wherein at least one second sliding post is disposed on the second sliding board, corresponding to the second sliding slot, and is mounted inside the second sliding slot.

4. The device according to claim 1, wherein a following pulley is disposed on one end of the first sliding board and the transmission belt is put on the following pulley.

5. The device according to claim 1, wherein the driving pulley is a toothed pulley.

6. The device according to claim 1, wherein the driving mechanism having a motor, a driving gear set, and a driving linkage mechanism; one end of the driving linkage mechanism is disposed on the base chassis while the other end thereof is arranged on the first sliding board and the driving gear set is disposed on the base chassis and the driving linkage mechanism, engaging with the driving pulley as well as a worm of the motor thus the motor drives the driving pulley to rotate.

7. The device according to claim 6, wherein the driving linkage mechanism having a first driving link and a second driving link; one end of the first driving link is arranged on the base chassis and the other end of the first driving link is connected with one end of the second driving link while the other end of the second driving link is disposed on the first sliding board.

8. The device according to claim 1, wherein an elastic component is hooked between the first synchronous gear and the second synchronous gear.

9. The device according to claim 1, wherein a starting block is arranged on the bottom of the second synchronous gear; when an optical disk is pushed into the disk drive to drive the second sliding board moving, then the second synchronous link is moved to drive the second synchronous gear to rotate so that the starting block contacts a starting switch on the base chassis to activate the driving mechanism to rotate the driving gear set.

10. The device according to claim 1, wherein a positioning bar with a positioning post on one end thereof is disposed on the base chassis; the positioning post is used to press the top of the optical disk and position the optical disk while the transmission belt drives the optical disk entering into the disk drive.

11. The device according to claim 10, wherein an elastic component with one end hooked on the base chassis is hooked on the other end of the positioning bar.

12. The device according to claim 1, wherein the base chassis further having a base board for being disposed with the second sliding slot, the first synchronous gear and the second synchronous gear.

13. The device according to claim 1, wherein a transverse-moving member and a sliding member are disposed on the base chassis; the sliding member is arranged beside the first sliding board and is driven by the driving mechanism to move upwards and downwards; the transverse-moving member is disposed on lateral side of the top of the sliding member and having a first lift slot with slope on lateral side as well as a transverse-moving post on one end thereof inserting into a transverse-moving slot on the bottom of the sliding member; a second lift slot is disposed on lateral side of the sliding member; lift arms disposed on two lateral sides of the front end of a traverse on the base chassis are mounted on the first lift slot and the second lift slot respectively; when the transmission belt drives the optical disk into the disk drive, the driving mechanism makes the sliding member to move, then the sliding member drives the transverse-moving member and the first lift slot as well as the second lift slot guides the lift arms to move upwards so that the traverse is moved upwards to load the positioned optical disk on a turn table of the traverse.

14. The device according to claim 13, wherein an elastic component with one end hooked on the base chassis is hooked on top of the sliding member.

15. The device according to claim 13, wherein a gear rack is disposed on the lateral side of the lower part of the sliding member and the driving mechanism having a motor and a driving gear set; the driving gear set engages with the gear rack and a worm of the motor so that the motor drives the driving gear set and further moves the gear rack to make the sliding member move.
